(19) United States
(12) Patent Application Publication
(10) Pub. No.: US 2008/0125146 A1
(43) Pub. Date: May 29, 2008

(54) Accurate Timing of Sms Messages

(76) Inventor: David Bainbridge, London (GB)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 11/579,024

(22) PCT Filed: May 3, 2005
(86) PCT No.: PCT/GB05/01685

§ 371 Date: Oct. 12, 2007

(30) Foreign Application Priority Data
Apr. 30, 2004 (GB) 0409712.7

(51) Int. Cl. H04Q 7/20

(52) U.S. Cl. 455/466

(57) ABSTRACT

A method of obtaining timing information regarding the sending of an SMS messages across a mobile communications network is described. The method comprises: receiving an SMS message forwarded via the local SMSC to the virtual mobile telephone number of a virtual mobile redirector unit, the SMS message incorporating timestamp information specified by the time of receipt of the message as determined by a local clock of the local SMSC and addressing information; extracting the message data, the address information and the timestamp information from the SMS message; creating a new data message addressed by the address data and containing the timestamp information and the message data; transmitting the new data message to an application server for processing of the message data and the timestamp information; and acquiring the transmitted new data message at the application server, processing the message data and the timestamping information and compiling the results.

### FIELD OF THE PRESENT INVENTION

The present invention concerns improvements relating to telecommunications and relates, more specifically, to a method of delivering data messages between a mobile telecommunications device and a computing application.

### BACKGROUND TO THE PRESENT INVENTION

When mobile phones were introduced commercially in the late 1970s, their primary function was to handle audio data. The first generation (1G) of mobile phones worked using analogue technology and gave users the freedom to make telephone calls from ‘any’ location via a wireless cellular network. Under the ‘cellular’ system, geographic locations are divided by Network Operators into areas, or ‘cells’, of around ten square miles. Each cell has a proprietary base station at its centre which transmits and receives radio signals to and from mobile phones, hosted by that Network Operator, within the surrounding cell area. The base stations then communicate with Mobile Switching Centres within their cellular network and these connect to the Public Service Telephone Network and other cellular networks via landlines.

The cellular networks were initially developed without the benefit of standardization, leading to inherent problems with compatibility. In addition, the purely analogue technology of first generation systems placed a severe limitation on network capacity. The Global System for Mobile Communications standards group was formed in 1982 to address these problems initially within Europe, but the resulting GSM guidelines have since been adopted throughout much of the world. The need to rapidly increase cellular capacity in a cost-effective manner lead to a decision to adopt Time Division Multiple Access (TDMA) technology, which makes more efficient use of the available radio spectrum by assigning time slots to different transmissions. In the second generation (2G) of mobile phones, voice signals are converted into high-frequency digital signals before being grafted onto a low-frequency analogue wave for transmission. This digital technique effectively triples the number of phone calls which can be handled by a cellular network at any one time.

As anticipated, the subsequent growth of digital cellular network systems has been rapid. However, users of the second generation phones caught the Network Operators somewhat unaware, by using them to send alphanumeric messages in addition to making voice calls. The users were exploiting another new communications protocol provided by the standards, namely the Short Messaging Service (SMS) which was originally devised to enable telecoms engineers to communicate across the networks.

Under the standards, the radio spectrum is divided into channels which occupy specific frequency bands. There are two different types of channel: communication channels, which carry voice signals, and control channels, which carry control signalling inputs and outputs from the communication channels and manage network transmission tasks. The Short Messaging Service takes advantage of spare frequency capacity within the control channels, allowing short alphanumeric messages of up to 160 characters in length to be communicated. The SMS facility was initially exploited by the Network Operators to provide voicemail services, whereby text messages are used to alert users to the existence of voice messages stored by their host network in a central repository. Typically, when a user reconnects their handset to a network, a text message such as “3 NEW MESSAGES” is transmitted to the phone and appears on the handset display screen.

In due course, the service was adapted so that short messages could originate from the mobile phones themselves and be sent to the network or to other mobile phones on which the service was enabled. The facility was enthusiastically embraced by users, so much so that billions of SMS messages are now sent every month to and from a whole range of telecommunications devices.

Of course, it did not take long for businesses to realise the potential of this new communications medium, a medium which vast numbers of users were already demonstrating their affinity. Visionaries anticipated that SMS would allow commercial services and products to be conveniently accessible to users from virtually any location. Accordingly, the Network Operators were soon being approached to host commercial computing applications on their networks which would be accessible to users of mobile telecommunications devices via the short messaging service.

Whilst mobile telecommunications devices can be thought of as communicating with the ‘front’ ends of cellular networks, Network Operators have traditionally incorporated SMS applications into the ‘back’ ends of their networks, so that the higher volume traffic generated by applications does not interfere with the network capacity. With reference to FIG. 1, a telecommunications system 100 for handling SMS messaging is now briefly described, together with details of how cellular networks host SMS applications according to the prior art.

The telecommunications system 100 is comprised of first and second mobile telecommunications devices 102 and 104, which are hosted by a cellular network 106, and an application hosting system 108 which communicates with the network 106 through a wired connection via the Internet 110. The cellular network 106 comprises a series of interconnected internal processing units and a plurality of external base stations which are distributed across the geographical area assigned to the Network Operator.

When an SMS message is sent from the first mobile telecommunications device 102 to the second mobile telecommunications device 104, it is transmitted from the first device 102 via radio waves which are detected by a base station 112 in the local vicinity. The base station 112 then forwards the message to a first local Mobile Switching Centre (MSC) 114 within the cellular network 106, which provides an interface between the radio subsystem and the wired network.

Within the cellular networks short messages are processed by Short Message Service Centres (SMSCs), with each mobile telecommunications device being assigned a ‘home’ SMSC to handle messaging for that device. In addition to the 160 alphanumeric characters that it may contain, a short message is comprised of a header containing an identifier for the originating telecommunications device, an identifier for that device's home SMSC and an identifier for the destination device. Accordingly, in FIG. 1, the first MSC 114 forwards the short message to an SMSC 116 for the first telecommunications device 102 (the home SMSC for the second mobile telecommunications device 104 is not shown in FIG. 1).

Information regarding the whereabouts, status and availability of any mobile telecommunications device is maintained by its host network in a Home Location Register (HLR) for that device. When an activated mobile telecommunications device is transported around by a user, it moves through different cell areas of the host network; the network's base stations detect its presence and forward the information so that the device's HLR can be updated appropriately. Thus, in FIG. 1, the SMSC 116 checks the HLR (not shown) for the second mobile telecommunications device 104 to determine its status and to obtain routing information for the short message, namely the address of a second MSC 118 which is local to the second device 104. After receiving the short message from the SMSC 116, the second MSC 118 forwards it to a base station 120 in the vicinity of the second mobile telecommunications device 104, from which point the message is re-transmitted as a radio wave and received by the second device 104.

The above describes the sending of a message between two mobile telecommunications devices 102, 104 which are hosted by the same cellular network 106, but when an SMS message is to be sent to a device hosted by a different network, the network of the originating device will not possess an HLR for the destination device. In this case, the home SMSC of the originating device will direct a routing request to a so-called gateway MSC (GMSC) through which connections are made to the networks of different Operators.

Having described how SMS messaging between mobile telecommunications devices is handled by the front ends of cellular networks, details of how SMS applications are hosted in the prior art now follow. The applications are configured to receive information from users via SMS messages, function in accordance with the received information, and then communicate back with the users via the SMS medium.

Each SMSC 116 is provided with an Application Interface 122 for hosting applications at the so-called ‘back-end’ of the network 106, away from the traffic generated by mobile telecommunications devices 102, 104. An application is assigned what is known as a ‘short code’, comprising a reduced number of digits compared to the usual mobile numbers, and the SMSC 116 is programmed to recognise short codes when they are received in the header of an SMS message so that the message is forwarded to the Application Interface 122 rather than being routed across the network 106.

Application Interfaces 122 were initially only intended to host proprietary applications for their own network, but further to the success of SMS messaging the Network Operators firstly allowed applications from third parties to be hosted internally on their Application Interfaces 122 and then allowed connections to be made into the Interfaces 122 from the Internet 110, or private proprietary Intranet circuits, by external application hosting systems 108, as can be seen from FIG. 1. In FIG. 1 the application hosting system 108 comprises an application server 124 and a so-called SMS Gateway 126, with the application server 124 executing an application 128. The Gateway 126 provides a hard-wired regimented interface to the network 106, performing such tasks as queuing messages either received for or to be sent from the application 128, determining availability of the application 128 and network 106 and sending confirmation to either the network 106 or the server 124, respectively, when a message is delivered.

With reference to FIG. 1, messages sent from the first mobile telecommunications device 102 to the application 128 are received by the network's base station 112 and then forwarded to the home SMSC 116 for that device 102, where they exit the network 106 through the Application Interface 122 and are transmitted over the Internet 110 to the SMS Gateway 126, which delivers them to the application server 124 on which the application 128 resides.

Conversely, messages sent from the application 128 to the first and second mobile telecommunications devices 102, 104 are received by the SMS Gateway 126 and then transmitted across the Internet 110 to the Application Interface 122 of the host network 106 which resides on the SMSC 116, wherein the SMSC 116 accesses the HLR for each device 102, 104 and then routes the messages to the MSCs 114, 118 which are local to those devices 102, 104, at which point the messages are forwarded to the base stations 112, 120 in nearest vicinity to the devices 102, 104, where they are, respectively, transmitted as radio waves for the first and second devices 102, 104 to receive.

There are now many services which are accessible to users through their mobile telecommunications devices—for example, in London the congestion charge can be paid via an SMS message.

Despite these advances, exploitation of the short messaging service has been hampered by its inability to support time-sensitive applications, that is applications which require information regarding when an SMS message was sent or received by a mobile telecommunications device. Whilst all SMSCs are configured to stamp messages with the time at which they are received and the time at which they are delivered to a recipient device, different networks employ timing systems which have different clocks, such that timing information received from one Network Operator cannot readily be compared against that received from another. Even across a single network, the clocks of different SMSCs may not be aligned, whilst the times taken to handle SMS messages can vary according to the method of payment associated with the message (for example, an SMS message sent from a mobile phone using a pre-paid mobile phone voucher will undergo different internal processing within a network to a message which is sent from a mobile phone having an associated account that is to be billed at a later date). Furthermore, whilst all SMSCs timestamp the messages they handle, they are not all configured to provide this timing information to external applications. This latter problem has arisen because the Application Interfaces of SMSCs are not subject to GSM standards and they have been developed with differing functionalities. However, even if an SMSC hosting an application is able to provide information on when messages sent by the application were delivered by the SMSC to mobile telecommunications devices, information regarding the time of any reply to such messages will either be unreliable or else not available. This is because the reply messages will be handled by different SMSCs, namely those of the sending devices, and these may not reference the same clock or else may not be configured to provide timing information.

These issues have proved particularly frustrating in the arena of interactive television programming where audiences are encouraged to participate in a programme via the short messaging service. Television audience figures typically run into millions and the revenues generated from such interactive aspects of a show can be vast. However, the above technical restrictions have prevented programme makers from developing real-time interactive forums in which audiences may participate and it is anticipated that a real-time competitive element would prove particularly attractive to the viewing public.

One possible solution to the above timing issues would be to standardise the Application Interfaces of the different SMSCs, such that they would all be able to provide timing information, and synchronise their clocks. However, this would require significant modification of the SMSCs which Network Operators have been reluctant to embark on because of the expense and risk to their networks. Any upgrades have associated development, testing and implementation costs, whilst any SMSC taken out of operation by a technical fault would have serious financial consequences for an Operator. In addition, standardising the Application Interfaces in this way would not address the internal timing differences which can occur depending on the method of payment associated with a message.

### SUMMARY OF INVENTION

It is desired to overcome or substantially reduce some of the abovementioned problems. More specifically, it is desired to provide a method of delivering short messages between mobile telecommunications devices and applications which enables the times messages were sent from, or received by, the devices to be determined in real-time without requiring modification of the SMSCs.

The present invention resides in the appreciation that a non-invasive solution to the timing problems outlined above lies at the ‘front’ of the networks rather than at the ‘back’ of the networks, namely through the adaptation of technology which enables messages between mobile telecommunications devices and applications to be communicated as if they were messages purely between mobile telecommunications devices.

More specifically, according to one aspect of the present invention there is provided a method of obtaining timing information regarding the sending of an SMS messages across a mobile communications network, the method comprising: receiving an SMS message forwarded via the local SMSC to the virtual mobile telephone number of a virtual mobile redirector (VMR) unit, the SMS message incorporating timestamp information specified by the time of receipt of the message as determined by a local clock of the local SMSC and addressing information; extracting the message data, the address information and the timestamp information from the SMS message; creating a new data message addressed by the address data and containing the timestamp information and the message data; transmitting the new data message to an application server for processing of the message data and the timestamp information; and acquiring the transmitted new data message at the application server, processing the message data and the timestamping information and compiling the results.

The present invention therefore resolves the problem of inconsistency in timestamping data being available via different application interfaces by redirecting all messages to the VMR unit and then having an application there which allow this data to be extracted and forwarded onto the application server. This solution is very advantageous as none of the SMSC's application interfaces are required to be modified in any way to pass timing information. Further, timing information is always available as messages are only passed between SMSCs before reaching the VMR where the timestamping information is extracted.

The acquiring step may comprise acquiring the new data message at the application server via an SMS gateway. This is advantageous as the SMS gateway can control two-way communication if desired back to the sender of the original message.

The transmitting step may comprise transmitting the new data message across a wide-area network, such as the Internet to a remote application server. This advantageously enables the system design to be modular with different parties operating different aspects independently. Alternatively, the application server may reside at the VMR unit and the transmitting step may comprise routing the new message to the VMR unit. Providing the server in the VMR unit makes the process of obtaining the timing data and processing it faster and more robust as communications over a wide area network are no longer required.

The acquiring step may comprise routing the new data message to a specific one of a plurality of applications running on the application server as determined by the addressing information. This routing enables a plurality of applications to run concurrently on the application server thereby providing economies of scale for example.

The method may further comprise forwarding the compiled results to a broadcast server in real time. This enables real-time reporting of the interaction with, for example, a broadcast program to be provided and also enables timing information regarding Mass Text Voting for example to be reported on far more quickly and accurately than has been the case previously.

Preferably the processing step comprises extracting the mobile communications address of the sender of the message; using this to address a question message and sending the question message back to the sender. This not only allows two-way communication with each individual sender but also opens up a new field of time measurement, namely that of user response times. The ability to measure the response time of each user accurately and in an un-biassed manner enables a whole new raft of interactive gaming techniques to be employed which in itself leads to new types of interactive games being possible.

One practical way of doing this is to make the sending step comprise routing the question message via an SMS gateway directly to an application interface residing at an SMSC which can send the question message onto the sender. Timing information can simply be obtained by requesting a timestamped delivery receipt from the SMSC indicating the delivery time at which the question message is actually delivered to the sender.

The problem of different SMSCs using different clocks for timestamping is addressed by the method further comprising synchronising the timestamp information with a global clock of the application server. By knowing the differences between each clock used in timestamping and the actual global clock, the timestamps can be corrected (synchronised). This advantageously means that timing information can be compared from different networks to determine the fastest response for example to a broadcast question.

The synchronising step may comprise creating an offset table storing the clock timing differences between each SMSC and a global clock; generating a corrected timestamp or delivery time by subtracting the offset from the original timestamp information or delivery time; and storing the corrected timestamp or delivery time for valid comparison to other corrected timestamps or corrected delivery times. Using lookup tables is a fast practical way of carrying this out which also enables independent updating of the offset information to occur.

The synchronising step may also comprise: creating an offset table storing the clock timing differences between each SMSC and a global clock for each SMSC; extracting the timestamp information and local SMSC ID from a received SMS message; using the local SMSC ID to look up a corresponding entry in the offset table; creating a corrected timestamp by subtracting the offset from the original timestamp information; and storing the corrected timestamp for valid comparison to other corrected timestamps.

The creating step may advantageously comprise: generating a test message with a request for a delivery receipt; sending the test message to a specific SMSC using a SIM card of that SMSC; recording the sending time on a global clock; receiving the delivery receipt, including a delivery timestamp; extracting delivery timestamp information; determining a time offset for the specific SMSC by subtracting the delivery timestamp information from the sending time; and storing the determined offset in the offset table.

The creating step may further comprise repeating the generating, sending, recording, receiving determining and storing steps for each of the possible SMSCs in a given geographical region.

The present invention also extends to a system for obtaining timing information regarding the sending of an SMS messages across a mobile communications network, the system comprising: receiving means for receiving an SMS message forwarded via the local SMSC to the virtual mobile telephone number of a virtual mobile redirector unit, the SMS message incorporating timestamp information specified by the time of receipt of the message as determined by a local clock of the local SMSC and addressing information; extracting means for extracting the message data, the address information and the timestamp information from the SMS message; creating means for creating a new data message addressed by the address data and containing the timestamp information and the message data; a transmitter for transmitting the new data message to an application server for processing of the message data and the timestamp information; and an application server for acquiring the transmitted new data message, processing the message data and the timestamping information and compiling the results.

According to another aspect of the present invention there is provided a method of measuring a response time of a known mobile telecommunications device user, the method comprising: sending an SMS question message to the local SMSC of the known mobile telecommunications device with a request for a timestamped delivery receipt from the local SMSC, the timestamped delivery receipt indicating a delivery time at which the question message is actually delivered to the known mobile telecommunications device; processing the received timestamped delivery receipt from the local SMSC and storing the delivery time; receiving a response message forwarded via the local SMSC to the virtual mobile telephone number of a virtual mobile redirector unit, the response message incorporating timestamp information specified by the time of receipt of the message as determined by the local clock of the local SMSC and addressing information; extracting response message data, address information and the timestamp information from the response message; processing the response message data and timestamp information to determine a sending time for the response message to the questions message; and subtracting the delivery time from the sending time to determine the response time of the mobile telecommunications device user to the question message.

The advantages of this aspect of the present invention have been described above in relation to sending a question message back to the sender.

According to another aspect of the present invention there is provided a method of synchronising timestamp information added to an SMS message by a local SMSC, the method comprising: creating an offset table storing the clock timing differences between each SMSC and a global clock for each SMSC; extracting the timestamp information and local SMSC ID from a received SMS message; using the local SMSC ID to look up a corresponding entry in the offset table; creating a corrected timestamp by subtracting the offset from the original timestamp information; and storing the corrected timestamp for valid comparison to other corrected timestamps.

The advantages of this have been discussed above in relation to synchronisation of timestamping information with a global clock

### BRIEF DESCRIPTION OF THE DRAWINGS

A method and apparatus according to a preferred embodiment of the invention for delivering messages between mobile telecommunications devices and computing applications will now be described by way of example, with reference to the accompanying drawings in which:

FIG. 1 is a schematic block diagram showing a telecommunications system for delivering messages between mobile telecommunications devices and computing applications according to the prior art;

FIG. 2 is a schematic block diagram showing a telecommunications system for delivering messages between mobile telecommunications devices and computing applications that are hosted on a real-time application platform, in an exemplary embodiment of the present invention;

FIG. 3a is a flow diagram showing the steps involved in delivering a message from a mobile telecommunications device to an application hosted on the real-time platform of FIG. 2;

FIG. 3b is a flow diagram showing the steps involved in delivering a message from an application hosted on the real-time platform of FIG. 2 to a mobile telecommunications device;

FIG. 4 is a table of results data showing timing information obtained by the processes described in FIGS. 3a and 3b;

FIG. 5a is a schematic data record showing the data fields within a modified message delivered to the real-time application platform of FIG. 2 according to the process of FIG. 3a;

FIG. 5b (i) is a schematic data record showing the data fields within a message sent from the real-time application platform of FIG. 2 according to the process of FIG. 3b;

FIG. 5b (ii) is a schematic data record showing the data fields within a modified message delivered to the real-time application platform of FIG. 2 according to the process of FIG. 3b;

FIG. 6 is a schematic block diagram showing an SMS Gateway as employed by the real-time application platform of FIG. 2;

FIG. 7 is a schematic block diagram showing an application server as employed by the real-time platform of FIG. 2;

FIG. 8a is a flow diagram showing the steps involved in transmitting a message, delivered according to the process of FIG. 3a, from the SMS Gateway of FIG. 6 to the application server of FIG. 7;

FIG. 8b is a flow diagram showing the steps involved in transmitting a message, delivered according to the process of FIG. 3b, from the application server of FIG. 7 to the SMS Gateway of FIG. 6; and

FIG. 9 is a flow diagram showing the steps involved in determining a set of time offsets for a plurality of SMSCs within the telecommunications system of FIG. 2.

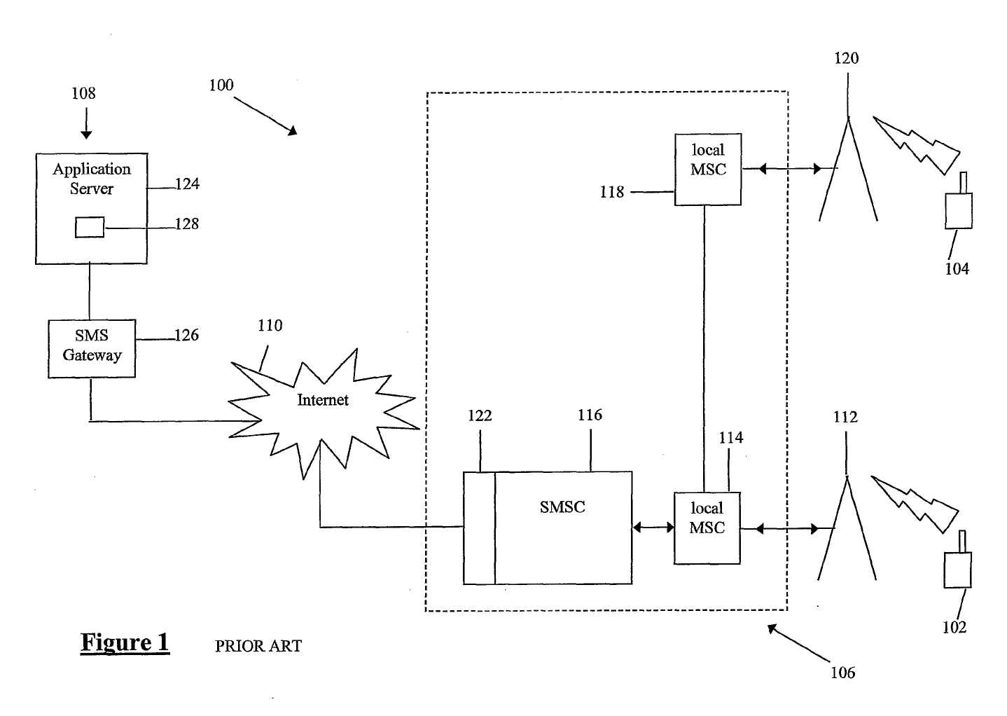

### DETAILED DESCRIPTION OF PREFERRED EMBODIMENTS OF THE PRESENT INVENTION

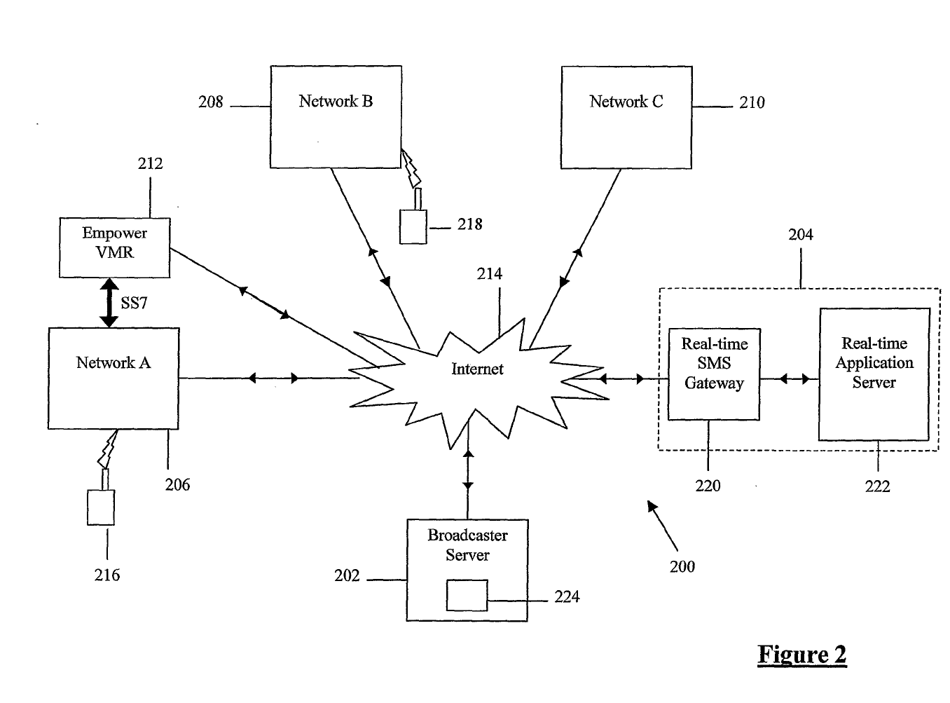

With reference to FIG. 2, a telecommunications system 200 for implementing a presently preferred embodiment of the present invention is now described. The telecommunications system 200 facilitates the hosting of a time-sensitive SMS application, such that the times when SMS messages are sent to the application or the times when SMS messages are received from the application can be determined. It enables a broadcaster to produce a television show incorporating real-time competitive interaction elements.

The telecommunications system 200 is comprised of a Broadcaster Server 202 that is associated with a television show, a Real-time Application Platform 204, a plurality of cellular networks (of which only three are shown in FIG. 2, namely Network A 206, Network B 208 and Network C 210) and a Virtual Mobile Redirector (VMR) unit 212, all of which are connected to the Internet 214; the Virtual Mobile Redirector unit 212 additionally communicates with cellular Network A 206 via the telecommunications protocol SS7 used within cellular networks. Whilst the cellular networks 206, 208 and 210 will host a plurality of mobile telecommunications devices, only two are shown in FIG. 2, namely a first mobile telecommunications device 216 hosted by Network A 206 and a second mobile telecommunications device 218 hosted by Network B 208.

An application associated with the television show is hosted by the Real-time Application Platform 204, which is comprised of a Real-time SMS Gateway 220 and a Real-time Application Server 222. The application can send and receive messages to and from the mobile telecommunications devices 216 and 218, as will be discussed in due course. Thereafter, data from the application can be transmitted from the Real-time Application Platform 204 to the Broadcaster Server 202 for processing by a results module 224, enabling virtually real-time feedback from the audience to be broadcast within the television programme.

The internal workings of the cellular networks 206, 208 and 210 when handling SMS messages have already been briefly summarised in this specification and are well understood from the prior art and so will not be repeated here. The Virtual Mobile Redirector unit 212 associated with Network A 206 is that devised by Empower Interactive Group Limited, as described in their International patent application WO-A-03/001819 and adapted to accommodate the present embodiment. The functionality of the Virtual Mobile Redirector is described below.

As well as the prior art timing problems that are associated with hosting SMS applications on the Application Interfaces of SMSCs (described previously), there are also compatibility and scalability problems. The short codes which identify applications at Application Interfaces are proprietary and are not shared between all SMSCs; if an SMSC receives a message for a short code that it does not recognise it will ignore the user's message and not deliver it. In addition, the same short code for an application cannot always be reserved on different SMSCs, such that users from different networks may be required to use different codes for the same application, which is not attractive to broadcasters. Scalability issues arise when large numbers of messages are sent to the same application in a very short period of time (for example, as many as 2.5 million SMS votes can be received within an hour on Big Brother eviction nights). SMSCs do not have the inherent flexibility required to react to such events—an increase in SMS capacity for an application can sometimes take months to achieve.

Empower's Virtual Mobile Redirector solves the compatability and scalability problems described above by allowing applications to be hosted at the ‘front’ ends of networks. The VMR is assigned a range of ‘virtual’ mobile numbers by a particular network and each application hosted by the VMR is allocated its own virtual mobile number. Accordingly, rather than routing messages to Application Interfaces, each SMSC treats messages for an application as though they are intended for a mobile telecommunications device and routes them to the local MSC which hosts the VMR. The local MSC then delivers the messages via the usual SS7 network communications protocol. The compatibility issue disappears because SMSCs are designed to handle SMS messages destined for any other mobile telecommunications device, whilst with regard to scalability SMSCs are already capable of handling traffic spikes (for example, on New Year's Eve).

Returning to the invention at hand, the present inventor has realised that, in addition to solving the compatibility and scalability problems discussed previously, Empower's VMR can be configured to extract timing information concerning messages bound for applications, since this information is available through the SS7 communications protocol. Therefore, the use of a single application interface for all SMS messages overcomes the prior art problems associated with the non-uniform handling of messages across application interfaces of the different SMSCs.

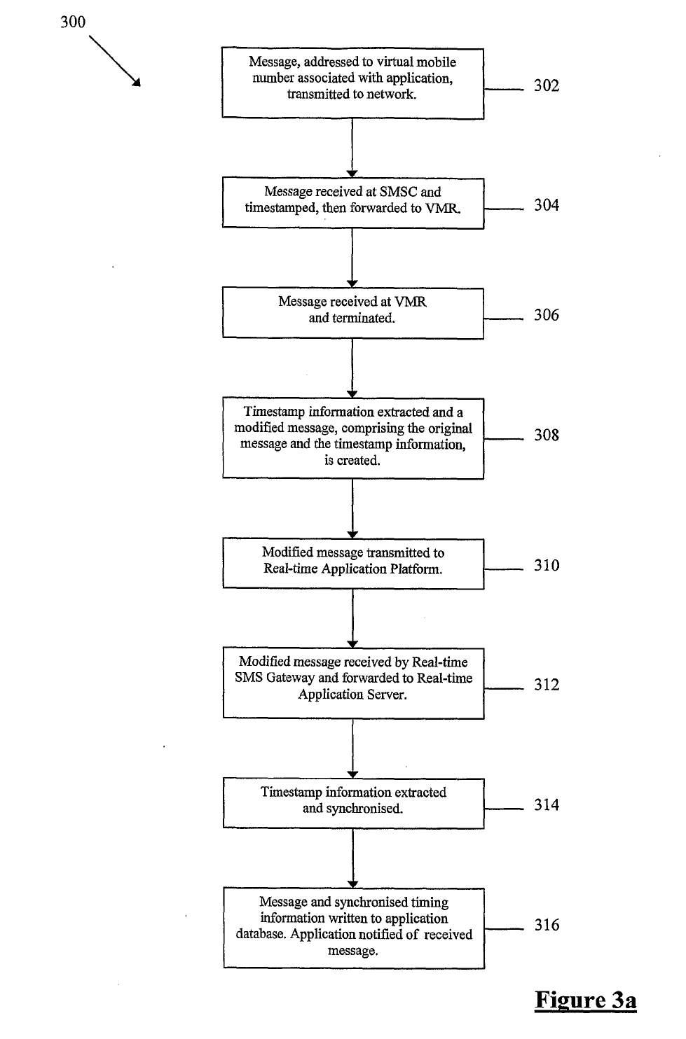

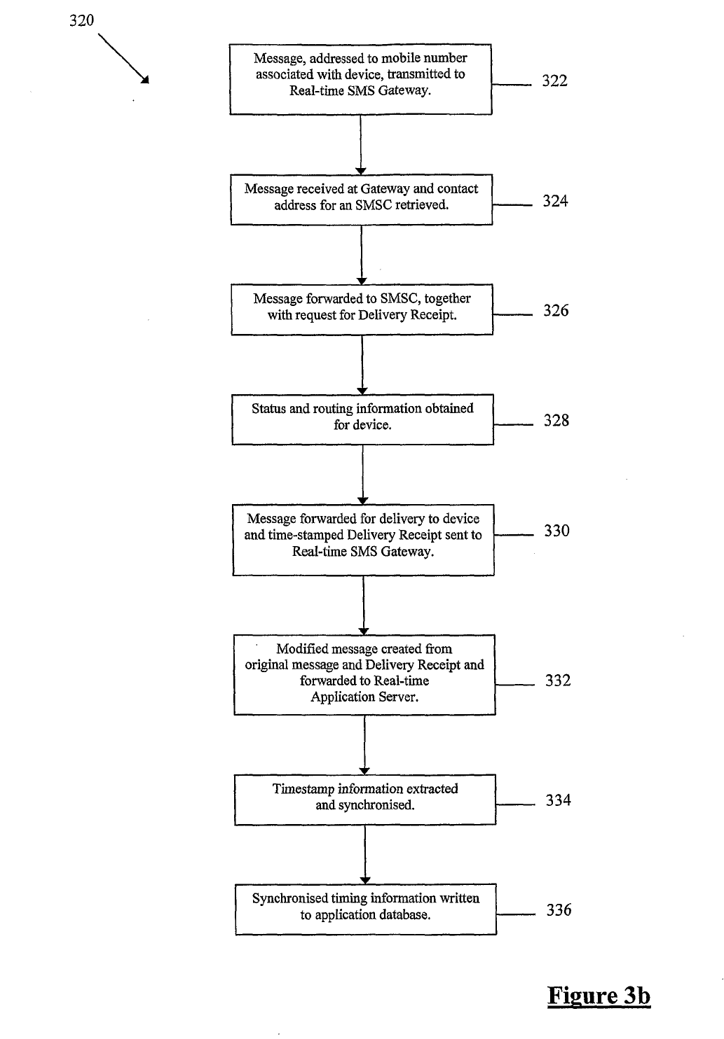

With reference to FIGS. 3a and 3b, respectively, processes for sending a message from a mobile telecommunications device to the application associated with the broadcaster's television show and for sending a message from the application back to the mobile telecommunications device, using the telecommunications system 200 of FIG. 2, will now be described.

A so-called mobile-originate messaging process 300, shown in FIG. 3a, occurs when a message is sent from a mobile telecommunications device to the application residing on the Real-time Application Server 222. As well as delivering the message to the application, the mobile-originate messaging process 300 is able to inform the application of the time that the message was sent from the mobile telecommunications device. In the example that follows, a message is described as being sent to the application from the first mobile telecommunications device 216, although a message is also transmitted from the second mobile telecommunications device 218.

The process 300 begins after a user of the first telecommunications device 216 in FIG. 2, who is watching the television programme, is invited to send a message to a ‘virtual’ mobile number associated with the television programme. In the description that follows, the user initially responds to a first question that is posed by the television show presenter. The ‘virtual’ number actually identifies the application associated with the television programme, whilst the user is instructed to include in the body of the message itself, along with their answer, a question ID which identifies the question to the application. The user composes an appropriate message, addressing it to the indicated virtual mobile number, and then commences the mobile-originate messaging process 300, at step 302, by using the first mobile telecommunications device 216 to transmit the message to its host network, namely Network A 206.

The message is delivered to the home SMSC for the first mobile telecommunications device 216 in the usual way (see earlier description). The time taken for the message to be transmitted to a local base station is negligible. Thereafter, all wired network communications are conducted according to the SS7 protocol, which is effectively a real-time protocol whereby network events happen within fixed periods of time. Upon receiving the message at step 304, the home SMSC references its internal clock and timestamps the message. Given that the time taken for a message to be delivered from a base station to a home SMSC is of the order of milliseconds, the timestamp can be taken to give the time at which the message was transmitted from the first mobile telecommunications device 216. The SMSC then locates the HLR for the virtual mobile number and routes the message to the appropriate MSC, which also uses the SS7 communications protocol to forward the message to the Empower VMR unit 212. In accordance with the SS7 protocol, the message is transmitted across the network as a ‘package’ of information, in which the SMSC timestamp is included.

The Empower VMR unit 212, upon receiving the message package at step 306, terminates the message as if it had been delivered to a ‘real’ mobile telecommunications device, such that the procedure followed by Network A 206 in delivering the message is the same as that for a message sent between actual mobile devices. Thereafter, the VMR unit 212 is configured to recognise, from the mobile number to which the message is addressed, that the message is destined for the Real-time Application Platform 204 and, at step 308, the Empower VMR unit 212 extracts the timestamp information from the message package delivered via the SS7 communications protocol and creates a modified message by taking the original message and incorporating into it the timestamp information as an additional data field.

The Empower VMR unit 212 goes on to establish a wired connection, via the Internet 214, with the Real-time SMS Gateway 220 and, at step 310 in the mobile-originate messaging process 300, the modified message is transmitted to the Real-time Application Platform 204.

The Real-time SMS Gateway 220 is configured to accept modified messages, that is short messages incorporating at least one additional field, and at step 312 the Gateway 220 receives the modified message sent by the Empower VMR unit 212 and forwards it to the Real-time Application Server 222 for processing.

Upon receiving the modified message at step 314, the Real-time Application Server 222 extracts the timestamp information and amends it to account for the timing system used by the originating SMSC (this process will be described in more detail in due course); it also identifies the application, the question and the mobile telecommunications device to which the data relates (again, this will be described in more detail in due course). Thereafter, at step 316, the Real-time Application Server 222 stores the modified message in a database associated with the television programme application and notifies the application of the received message, thereby completing the mobile-originate messaging process 300.

Accordingly, the application residing on the Real-time Application Server 222 can obtain, from its database, the correct time at which the message was sent from the first mobile telecommunications device 216. The application can then provide the Broadcaster Server 202 with details of the quickest correct replies to the first question posed in the television programme, allowing prizes to be awarded on a fair basis.

In contrast, a so-called mobile-terminate messaging process 320, shown in FIG. 3b, occurs when a message is sent back to a mobile telecommunications device from the application residing on the Real-time Application Server 222. As well as delivering the message to the device, the mobile-terminate messaging process 320 is able to inform the application of the time that the message was received by the mobile telecommunications device. In the example that follows, a message is described as being sent from the application to the second mobile telecommunications device 218, but a message is also communicated to the first mobile communications device 216.

The mobile-terminate messaging process 320 begins, for example, after the presenter of the television programme informs the audience that a special second ‘bonus’ question is about to be sent out as an SMS message to all of the mobile telecommunications devices which participated in the previous interactive competition and that prizes will be awarded for the first correct messages sent in reply. At step 322 the application creates a message which is addressed to the second mobile telecommunications device 218 and this is transmitted from the Real-time Application Server 222 to the Real-time SMS Gateway 220. As well as containing the mobile number of the second mobile telecommunications device 218, the header of the message also contains the ‘virtual’ mobile number which is assigned to the application and the ID of the home SMSC for the second device 218, whilst the body of the message itself contains a question ID, which identifies the question to the application.

After receiving the message, the SMS Gateway 220 obtains a contact address for the Application Interface of an SMSC at step 324. Note that this address does not need to be for the home SMSC of the mobile telecommunications device to which the message is addressed, any SMSC will suffice. In the present example, an address for an SMSC Application Interface residing on Network C 210 is retrieved. At step 326 the SMS Gateway 220 establishes a connection to the SMSC within Network C 210 over the Internet 214 and forwards the message to the Application Interface, together with a request for a Delivery Receipt (as provided for in the GSM standards to confirm when a message has been delivered by an SMSC). The SMS Gateway 220 stores a copy of the message whilst awaiting a reply from the SMSC.

Further to the message being received, at step 328 the SMSC within Network C 210 accesses the HLR for the second telecommunications device 218 and, because the device 218 is hosted by a different network, namely Network B 208, it does this via a Gateway MSC (as described earlier). The SMSC checks the status information for the second telecommunications device 218, namely that the device 218 is available and able to receive messages, and obtains the appropriate routing information. If the device 218 is not available, then the SMSC retains the message and tries to deliver it later, rechecking the HLR at regular intervals until availability is confirmed.

At step 330, the SMSC within Network C 210 transmits the message to the second telecommunications device 218, using the SS7 communications protocol; at the same time the SMSC also issues a timestamped Delivery Receipt which is sent back to the Real-time SMS Gateway 220 via the Internet 214. Again, because under the SS7 communications protocol the time taken for a message to be delivered to a device further to it being transmitted from an SMSC is negligible, the timestamp can be taken to indicate the time at which the message was received by the second mobile telecommunications device 218.

The Real-time SMS Gateway 220 then creates a modified message at step 332, using the stored copy of the message and the timestamp information from the Delivery Receipt, and this message is then forwarded to the Real-time Application Server 222.

Upon receiving the modified message at step 334, the Real-time Application Server 222 extracts the timestamp information and amends it to account for the timing system used by the SMSC employed to deliver the bonus question message; it also identifies the application, the question and the mobile telecommunications device to which the data relates. Finally, at step 336, the Real-time Application Server 222 stores the synchronised timing information in a database associated with the television programme application, thereby completing the mobile-terminate messaging process 320.

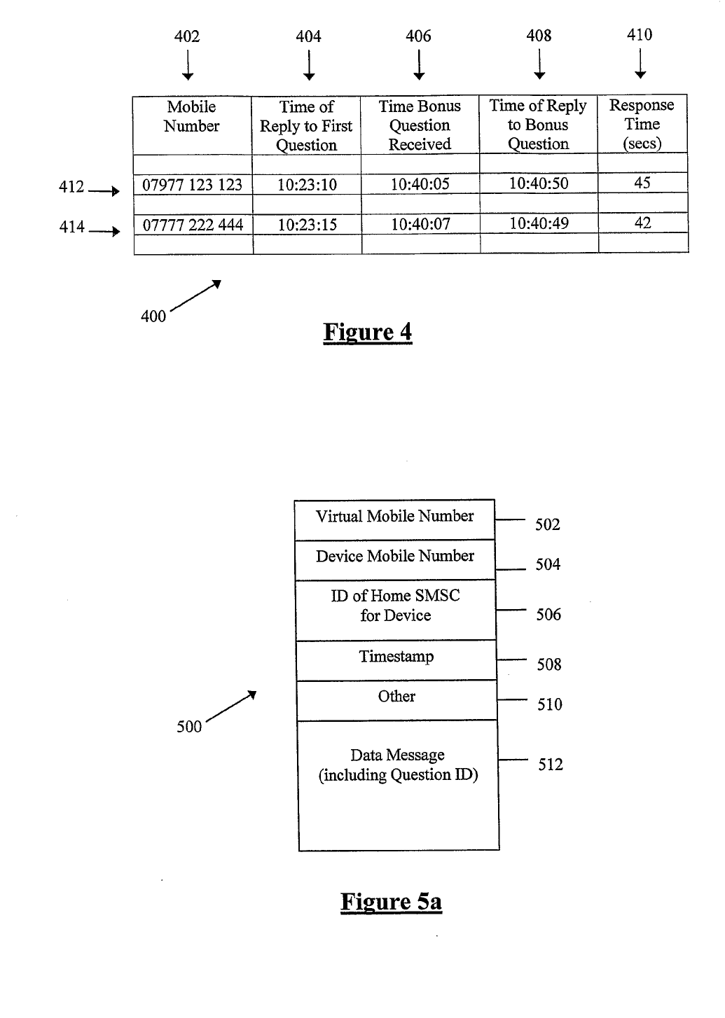

Accordingly, the application residing on the Real-time Application Server 222 can obtain, from its database, the correct time at which a message it sent was received by a mobile telecommunications device. Thereafter, when replies to the second ‘bonus’ question are received via the mobile-originate messaging process 300, the response times of the users of the first and second mobile telecommunications devices 216 and 218, respectively, can be compared. This is demonstrated by a table of results data 400 shown in FIG. 4.

The results table 400 comprises the following five columns of data: mobile number 402, time of reply to first question 404, time bonus question received 406, time of reply to bonus question 408 and response time 410. The table 400 may additionally comprise the answers supplied, but these are not shown in FIG. 4. For the purposes of the above described example, the table contains two entries of data: a first data entry 412 for the first mobile telecommunications device 216 and a second data entry 414 for the second mobile telecommunications device 218. From the example data, it can be seen that the first question, posed by the television programme's presenter, was answered fastest by the user of the first mobile telecommunications device 216; the second ‘bonus’ question, which the users received by SMS message, was responded to most quickly by the user of the second mobile telecommunications device 218.

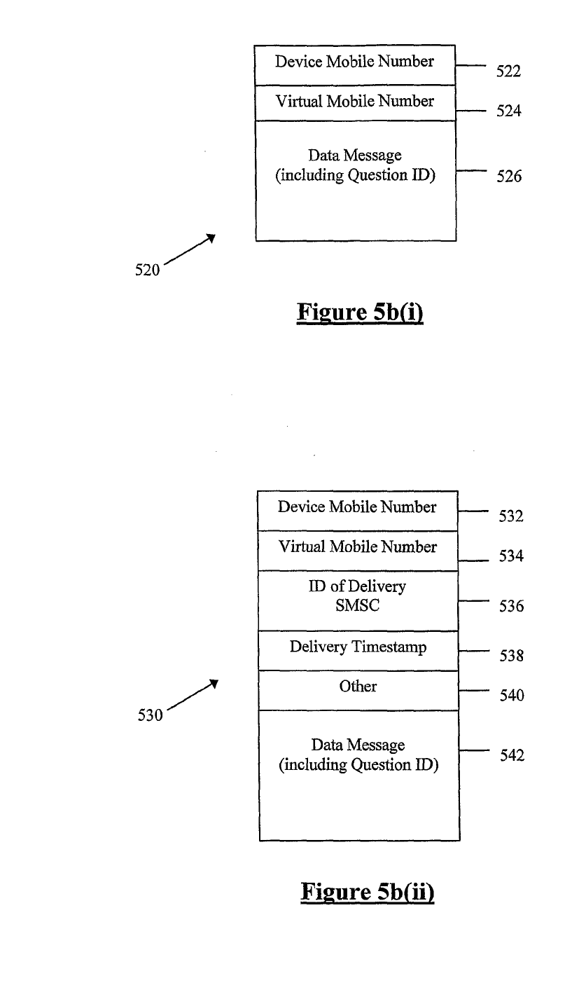

Schematic data records, showing the data fields in messages received and sent by the Real-time Application Platform 204 will now be described with respect to FIG. 5a and FIGS. 5b(i) and 5b(ii). Thereafter, the Real-time Application Platform 204 itself will be described in more detail.

A first data record 500, showing the data fields present in a modified message which is delivered to the Real-time Application Server 222 in response to the first question posed to the television audience, is shown in FIG. 5a. This message is created at step 308 in the mobile-originate messaging process 300. The record 500 comprises: a virtual mobile number field 502, which contains the virtual mobile number that identifies the application for which the message is intended to the Server 222; a device mobile number field 504 which contains the mobile number of the telecommunications device which sent the message; an SMSC ID field 506, which contains an identifier for the home SMSC associated with the sending device; a timestamp field 508 which contains the timestamp information extracted by the Empower VMR unit 212; an additional data field 510 in which ‘other’ information may be inserted by the VMR unit 212; and a data message field 512 which contains the alphanumeric message text composed by the sender. This last field 512 also contains a question ID to identify the question in response to which the message was sent.

A second data record 520, showing the data fields present in a message which is sent from the Real-time Application Server 222 as a second ‘bonus question’ to those who responded to the first question, is shown in FIG. 5b(i). This message is transmitted at the start of the mobile-terminate messaging process 320, at step 322. The record 520 comprises: a device mobile number field 522, containing the mobile number of a device which responded to the first question; a virtual mobile number field 524, which contains the virtual mobile number associated with the application for the television programme; and a data message field 526 in which the second bonus question is written, which includes an identifier for identifying the bonus question posed by the application.

A third data record 530, showing the data fields present in a modified message which is sent to the Real-time Application Server 222 upon delivery of the bonus question, is shown in FIG. 5b(ii). This message is created by the Real-time SMS Gateway 220 at step 332 in the mobile-terminate messaging process 320. The record 530 comprises: a device mobile number field 532, containing the mobile number of the device to which the second data record 520 was delivered; a virtual mobile number field 534, which contains the virtual mobile number that identifies the application which sent the bonus question; an SMSC ID field 536 containing the ID of the SMSC that delivered the bonus question; a timestamp field 538 which contains the timestamp information returned to the Real-time SMS Gateway 220 in the mobile-terminate messaging process 320 by the delivering SMSC at step 330; an additional data field 540 in which ‘other’ information may be inserted; and a data message field 542 which contains a copy of the second bonus question, including an identifier for identifying the question to the application.

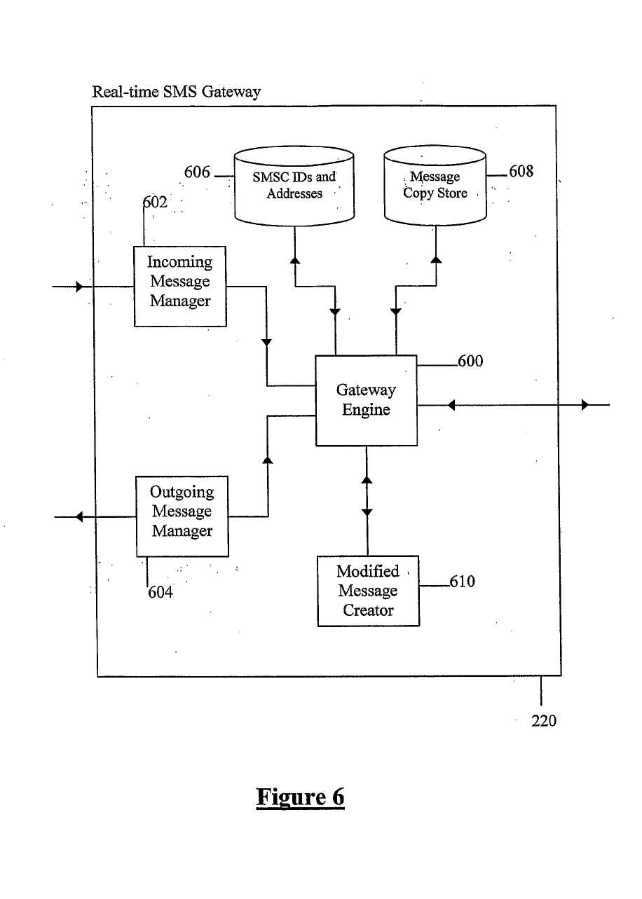

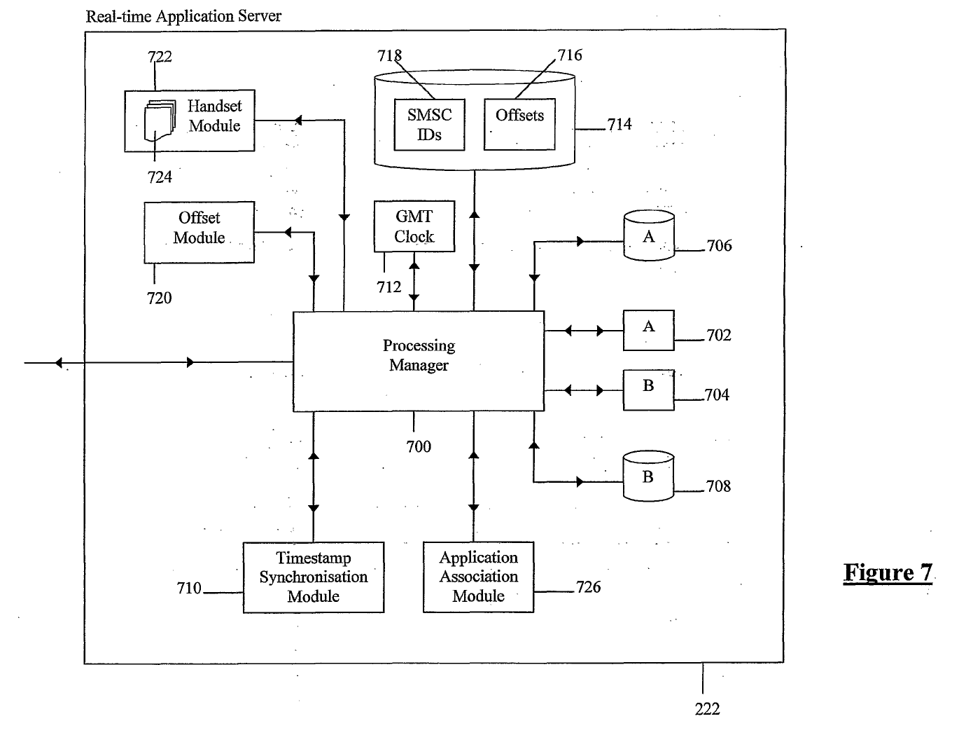

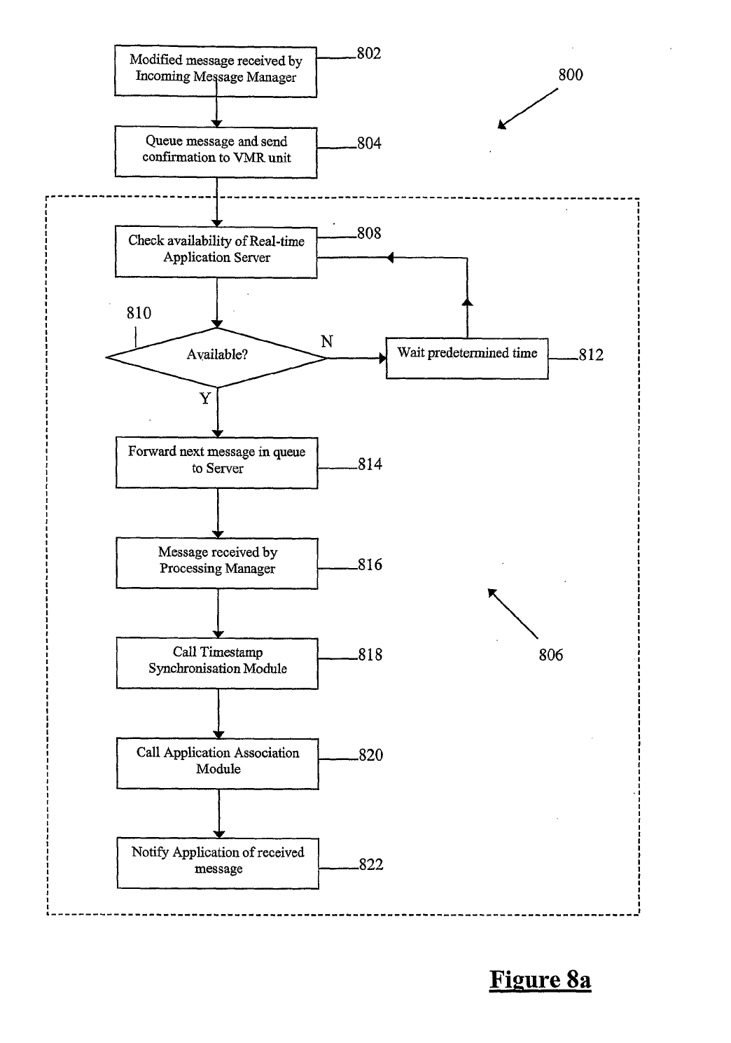

The Real-time Application Platform 204 which handles the data records described above will now be described in more detail with reference to FIGS. 6 and 7. The Real-time SMS Gateway 220 will be described first, with reference to FIG. 6, followed by a description of the Real-time Application Server 222 with reference to FIG. 7. Thereafter, the processing performed by both the Gateway 220 and the Server 222 during the mobile-originate messaging process 300 and the mobile-terminate messaging process 320 will be described.

The Real-time SMS Gateway 220 shown in FIG. 6 is comprised of a central Gateway Processing Engine 600, to which are connected: an Incoming Message Manager 602 for handling incoming messages to the SMS Gateway 220 and an Outgoing Message Manager 604 for handling messages to be transmitted from the SMS Gateway 220; a first database 606 for storing details regarding SMSCs and a second database 608 for storing message copies; and a Modified Message Creator 610 for amending a message copy to include timestamp information. The Gateway Engine 600 is additionally connected to the Real-time Application Server 222, whilst the two Message Managers, 602 and 604, are both connectable to the Internet 214.

At the hub of the Real-time Application Server 222, shown in FIG. 7, lies a central Processing Manager 700, to which all of the other applications, modules and databases connect. The Real-time Application Server 222 is host to a plurality of applications, of which only a first application A 702 and a second application B 704 are shown in FIG. 7. Also shown are the respective databases associated with these applications, namely a first database A 706 and a second database B 708. In addition to the applications, the Real-time Application Server 222 also contains a Timestamp Synchronisation Module 710 which aligns all recorded times with Greenwich Mean Time (GMT). In this regard, the Server 222 is provided with a GMT clock application 712. The Timestamp Synchronisation Module 710 refers to an offsets database 714, which contains a set of pre-calculated time offsets 716 for different SMSCs and the IDs 718 for those SMSCs. The offsets 716 are the time periods required to align the clocks of the SMSCs with GMT. In order to calculate the set of offsets 716, the Real-time Application Server 222 possesses an offset Processing Module 720 and also a Handset Module 722, which contains a plurality of SIM cards 724, for communicating with the SMSCs. Further to the timing data being aligned, the messages are associated with a particular application 702, 704 and written to an appropriate database 706, 708 by an Application Association Module 726. In addition to being connected to the above, the Processing Manager 700 also communicates with the Real-time SMS Gateway 220.

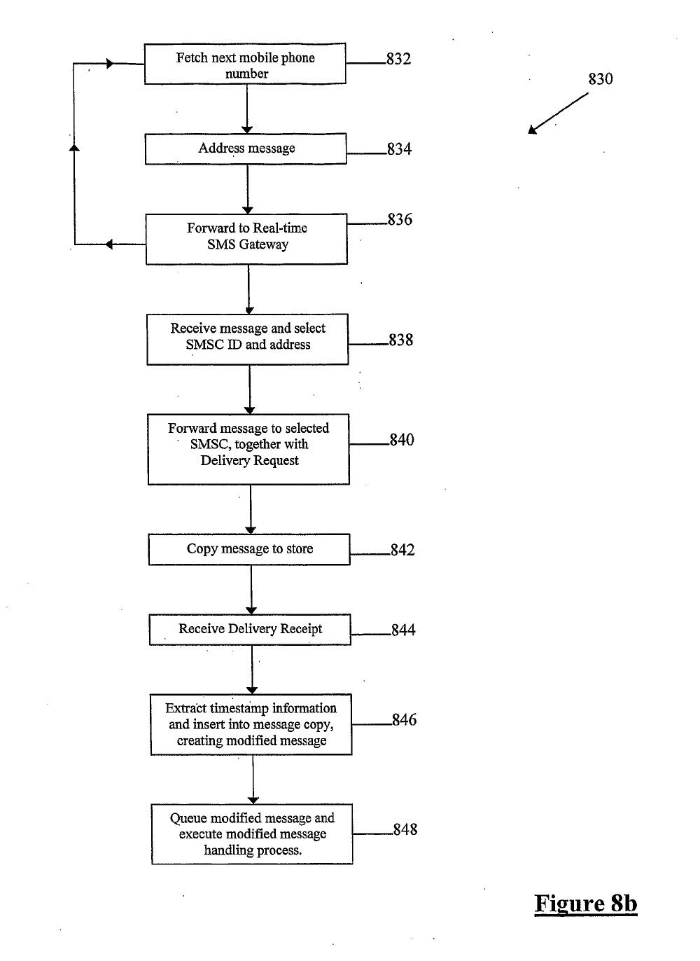

The processing steps conducted by the Real-time Application Platform 204 during the mobile-originate messaging process 300 will now be described in more detail with reference to a Real-time mobile-originate handling process 800 shown in FIG. 8a. As stated previously, the mobile-originate messaging process 300 takes place when a message is sent to an application 702, 704 from a mobile telecommunications device 216, 218.

The Real-time mobile-originate handling process 800 begins at step 802 when the Incoming Message Manager 602 of the Real-time SMS Gateway 220 receives a modified message from the Empower VMR unit 212. At step 804 the Incoming Message Manager 804 places the message in a processing queue and sends a message confirming delivery back to the VMR unit 212. Thereafter, the Real-time Application Platform 204 executes a modified message handling process 806. The Gateway Engine 600 within the Real-time SMS Gateway 220 is arranged to check the availability of the Real-time Server 222 at regular intervals. Accordingly, at step 808 within the modified message handling process 806, the Gateway Engine 600 sends an availability query to the Server 222 and assesses the reply at step 810. If the Server 222 is not available, then the Gateway 220 waits for a predetermined period of time at step 812 before repeating the query step 808. However, when availability is confirmed, the Gateway Engine 600 forwards the next modified message in the queue to the Real-time Applications Server 222 at step 814.

The modified message is received by the Processing Manager 700 within the Real-time Application Server 222 at step 816. The Processing Manager 700 then calls the Timestamp Synchronisation Module 710, at step 818, in order to convert the timestamp information 508 within the message to GMT. The Timestamp Synchronisation Module 710 extracts the timestamp information 508 and the ID of the issuing SMSC 506 from the modified message. It then uses the SMSC ID 506 to obtain the offset 716, associated with the SMSC which issued the timestamp 508, from the offsets database 714. The timestamp information 508 within the modified message is adjusted accordingly, producing an equivalent GMT timestamp.

When the time-corrected modified message is returned, the Processing Manager 700 calls the Application Association Module 726 at step 820 in the modified message handling process 806. This Module 726 extracts the virtual mobile number 502 from the message, which identifies the application 702, 704 for which the message is intended; it also extracts the question ID contained within the body of the message 512, so that if a series of questions have been posed in relation to the application 702, 704 the replies can be collated accordingly when the Application Association Module 726 writes the message to the database 706, 708 associated with the application 702, 704 (for example, as in the results table 400 of FIG. 4).

Further to these functions being completed by the Application Association Module 726, the Processing Manager 700, at step 822, notifies the relevant application 702, 704 that a message has been received.

The processing steps conducted by the Real-time Application Platform 204 during the mobile-terminate messaging process 320 will now be described in more detail with reference to a Real-time mobile-terminate handling process 830 shown in FIG. 8b. As stated previously, the mobile-terminate messaging process 320 takes place when a message is sent from an application 702, 704 to a mobile telecommunications device 216, 218.

The application 702, 704 composes a message to be sent to mobile communications devices 216, 218 and then addresses the message. At step 832 in the mobile-terminate messaging process 830, the application 702, 704 accesses its associated database 706, 708 where a list of mobile phone numbers 402 are stored. The first mobile number 402 is retrieved and the message is addressed to this number at step 834. The message is then sent to the Processing Manager 700 which forwards it from the Real-time Application Server 222 to the Real-time Application Gateway 220. The application 702, 704 repeats these steps 832 to 836 until messages have been sent to all of the relevant mobile phone numbers 402 held within its associated database 706, 708.

When the Real-time SMS Gateway 220 receives the message at step 838, via its Gateway Engine 600, it refers to its first database 606 which contains details for various SMSCs. A particular SMSC is selected at random and its associated ID and address are returned to the Gateway Engine 600, also at step 838. These details and the message itself are forwarded on to the Outgoing Message Manager 604, which establishes a connection to the relevant SMSC and transmits the message together with a request for a Delivery Receipt, at step 840. The Gateway Engine 600, at step 842, additionally writes a copy of the message to its second database 608 which stores message copies.

Further to the selected SMSC delivering the message, the Incoming Message Manager 602 receives the requested Delivery Receipt at step 844. This is forwarded to the Gateway Engine 600 which directs it to the Modified Message Creator 610. Here, the timestamp information within the Delivery Receipt is extracted at step 846 and then inserted into a copy of the original message as retrieved from the second database 608, thereby creating a modified message of the form shown in FIG. 5b(ii). At step 848 the modified message is added to the queue of messages which is maintained by the Real-time SMS Gateway 220, whereafter the modified message handling process 806 (shown in FIG. 8a and already described as part of the mobile-originate handling process 800) is executed.

The modified message handling process 806 proceeds as described previously except for when the Processing Manager 700 calls the Application Association Module 726 at step 820. The format of the modified message in the mobile terminate handling process 830 is that of FIG. 5b(ii) rather than FIG. 5a, which is the form received in the mobile originate handling process 800. Accordingly, the device mobile number 532 precedes the virtual mobile number 534 rather than following it. This is noted by the Application Association Module 726, when extracting the virtual mobile number 534 from the message, and signifies to it that the message relates to a mobile-terminate message sent by the application 702, 704, rather than to a mobile-originate message received from a mobile telecommunications device 216, 218. Accordingly, the Application Association Module 726 is able to make appropriate entries in the database 706, 708 associated with the application 702, 704. So, for the example results table 400 shown in FIG. 4, the ‘time bonus question received’ column 406 would be populated.

Accordingly, the telecommunications system 200 of FIG. 2 facilitates the delivery of messages between an application 702, 704 and mobile telecommunications devices 216, 218 in a way which enables the Real-time application platform 204 to provide the application 702, 704 with GMT-synchronised times of when messages were sent from mobile devices 216, 218 (see data fields 404 and 408 in FIG. 4) and when messages were received by mobile devices 216, 218 (see data field 406). This revolutionary system 200 allows competitive interactive elements to be incorporated into television programmes, providing a normalised timing environment which is fair to all participants. The GMT-synchronised times can be forwarded by an application 702, 704 to the Broadcaster's Server 202 and processed by the results module 222 residing thereon. The system 200 also allows mass SMS voting results to be incorporated into a programme in effectively real time. In particular, messages sent through the system 200 are handled without undue delay and do not become ‘lost’ because of network legacy systems.

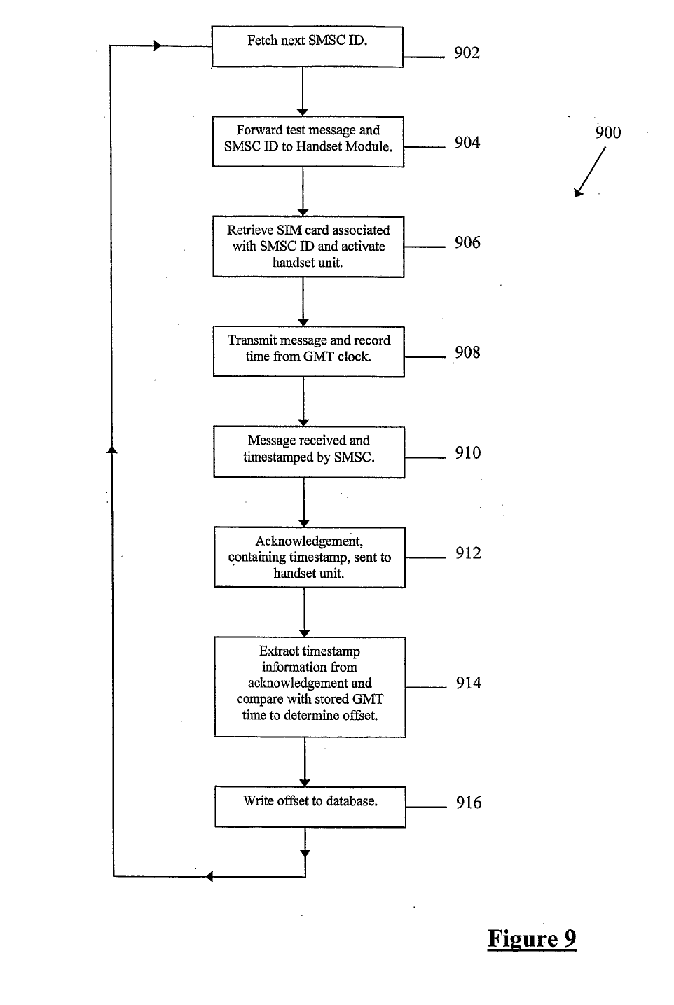

Details of how the timing data from different SMSCs and different networks is synchronised will now be described with reference to FIG. 9, in which an offset-determination process 900 is shown. The process 900 begins after the Processing Manager 700, which is scheduled to carry out a regular series offset checks, calls the Offset Module 720 to determine the offsets 716 for the SMSCs whose IDs 718 are stored in the offsets database 714. The Offset Module 720 duly selects the first SMSC ID 718 within the database 714 at step 902. It then forwards a test message and the SMSC ID 718 to the Handset Module 722 at step 904. The Handset Module 722, at step 906, uses the SMSC ID 718 to locate the SIM card 724 for that SMSC and then activates a handset unit (not shown) within the Module 722 using that SIM card 724. Next, at step 908, the handset unit transmits the test message as an SMS message, using the GMT clock 712 to record the time of sending. The test message can be addressed to any mobile number but it is preferable that it is addressed to the host network itself, to avoid the routing of any unnecessary traffic.

Further to the test message being detected by a local base station in the locality of the Real-time Application Server 222, it is forwarded to the home SMSC associated with the selected SIM card 724. Upon receiving the test message at step 910, the SMSC issues it with a timestamp as has been described previously. The SMSC then sends an acknowledgement of receipt to the handset unit, at step 912, containing the timestamp which confirms the time the message was sent. Again, because SS7 is a real-time communications protocol, the timestamp within the acknowledgement can be taken to give the time the message was sent from the handset unit according to the SMSC's internal clock.

The acknowledgement is received by the handset unit within the Real-time Application Server 222 and forwarded to the Offset Module 720, together with the internally recorded time of sending the test message. No further communication with the SMSC is required and so at this point the Handset Module 722 deactivates the handset unit by disengaging the SIM card 724. At step 914 within the offset-determination process 900, the Offset Module 720 extracts the timestamp information from the acknowledgement message and compares it with the time recorded by the Server's internal GMT clock 712. The difference between the two defines a small time period, or offset 716, which can be used to synchronise any other timestamps issued by that SMSC with GMT. Accordingly, at step 916 the Offset Module 720 uses the SMSC ID 718 to write the determined offset 716 to the offsets database 714, for future use in the mobile-originate and mobile-terminate handling processes 800 and 830, respectively. The Offset Module 720 then moves on to determining the offset 716 for the next SMSC ID 718 stored in the offsets database 716, repeating the above sequence of steps until offsets for all of the SMSC IDs 718 have been recorded.

With regard to scheduling of the offset-determination process 900, it is best conducted at off-peak times for network traffic so that the acknowledgement message does not get delayed.

Having described a particular preferred embodiment of the present invention, it is to be appreciated that the embodiment in question is exemplary only, and that variations and modifications, such as those that will occur to those possessed of the appropriate knowledge and skills, may be made without departure from the scope of the invention as set forth in the appended claims. For example, the Real-time Application Platform 204 could be incorporated as a whole into the Empower VMR unit 212, such that in addition to receiving messages destined for an application 702, 704, the unit 212 could additionally host the application 702, 704 too. Alternatively, only the SMS Gateway part 220 of the Real-time Application Platform 204 could be combined with the VMR unit 212, leaving the Real-time Application Server 222 as a remote entity. It will also be apparent that the central connections hub provided by the Internet 214 in FIG. 2 could readily be replaced by a private proprietary Intranet circuit, to which all of the cellular networks were connected.

In the foregoing description, even though the mobile-originate messaging process 300 is described for a message being sent from the mobile telecommunications device 216, which is hosted by the same network 206 that hosts the Empower VMR unit 212, the process 300 extends equally to messages sent from mobile devices 218 hosted by other networks 208, 210—the only difference being that the home SMSC of the sending device will communicate with the network that hosts the VMR unit 212 via a GMSC, enabling the message to be transferred across networks.

Although each application 702, 704 has been described as having a single ‘virtual’ mobile number assigned to it, such that different questions from an application are assigned different IDs, the questions themselves could be assigned different virtual mobile numbers, which the Application Association Module 726 within the Real-time Application Server 222 is then configured to recognise so that it can sort the messages accordingly.

Whilst in the context of the above embodiment, a first question is asked which prompts a first set of reply messages and this is followed by a second ‘bonus’ question which prompts a second set of reply messages, the mobile-originate messaging process 300 of the invention is not dependent on a second question being asked. Equally, in the mobile-terminate messaging process 320, the invention does not require a first question to be asked in order to obtain a set of mobile numbers to which a message from an application 702, 704 is to be addressed. Instead, an application 702, 704 could be provided with a predetermined set of mobile numbers to which it is desired to send a message and know the time of receipt of the message. For example, in a marketing scenario a supermarket may issue SMS vouchers to selected customers and then want to know how long it took for the vouchers to be redeemed after receipt.

With regard to time normalisation, in the embodiment all times are synchronised with Greenwich Mean Time, but the invention only requires that all times be standardised against the same clock which is internal to the Real-time Application Platform 204. Of course, there are many different ways in which the real-time nature of the SS7 communications protocol could be exploited to calculate the offsets 716, as will occur to those skilled in the art. In addition to correcting for any differences between clocks, the telecommunications system 200 can also be adapted to accommodate any handling delays which arise from different payment methods. For example, information concerning associated payment type could be incorporated in the data fields ‘other’ 510, 540 in FIGS. 5a and 5b(ii) and both payment accounts and prepaid vouchers could be associated with the SIM cards 724 employed by the Handset Module 722.

It is to be appreciated that there are many applications that would require the technology described in relation to the present invention in order to function accurately and in a fair manner. For example, user interaction with any broadcast quiz show that delivers an answer to a question on the viewer's screen and that requires viewers to interact (play-along) would needs the SMSC and broadcast play-out synchronisation of the present invention to be considered unbiased and presenting an equal chance of each viewer winning. The broadcast medium could be television or digital radio for example. Furthermore, new techniques for interactive gaming are enabled by the present invention. For example, by being able to measure user response time accurately, SMS quiz shows can be enabled where a registered user is sent an SMS question and the time it for him or her to respond determines whether they win.

Finally, it is to be appreciated that the term ‘mobile’ used herein refers to the frequency range by which a device communicates, rather than its portability, the invention does, of course, also extend to non-portable mobile telecommunications devices.

Having described particular preferred embodiments of the present invention, it is to be appreciated that the embodiments in question are exemplary only, and that variations and modifications, such as those which will occur to those possessed of the appropriate knowledge and skills, may be made without departure from the spirit and scope of the invention as set forth in the appended claims.

1. A method of obtaining timing information regarding the sending of an SMS messages across a mobile communications network, the method comprising:
receiving an SMS message forwarded via the local SMSC to the virtual mobile telephone number of a virtual mobile redirector unit, the SMS message incorporating timestamp information specified by the time of receipt of the message as determined by a local clock of the local SMSC and addressing information;
extracting the message data, the address information and the timestamp information from the SMS message;
creating a new data message addressed by the address data and containing the timestamp information and the message data;
transmitting the new data message to an application server for processing of the message data and the timestamp information; and
acquiring the transmitted new data message at the application server, processing the message data and the timestamping information and compiling the results.

2. A method according to claim 1, wherein the acquiring step comprises acquiring the new data message at the application server via an SMS gateway.

3. A method according to claim 1, wherein the transmitting step comprises transmitting the new data message across a wide area network, such as the Internet,

4. A method according to claim 1, wherein the application server resides at the virtual mobile redirector unit and the transmitting step comprises routing the new message to the virtual mobile redirector unit.

5. A method according to claim 1, wherein the acquiring step comprises routing the new data message to a specific one of a plurality of applications running on the application server as determined by the addressing information.

6. A method according to claim 1, further comprising storing the compiled results in a local database.

7. A method according to claim 1, further comprising forwarding the compiled results to a broadcast server in real time.

8. A method according to claim 1, wherein the processing step comprises extracting the mobile communications address of the sender of the message; using this to address a question message and sending the question message back to the sender.

9. A method according to claim 8, wherein the sending step comprising routing the question message via an SMS gateway directly to an application interface residing at an SMSC which can send the question message onto the sender.

10. A method according to claim 8, further comprising requesting a timestamped delivery receipt from the SMSC indicating the delivery time at which the question message is actually delivered to the sender.

11. A method according to claim 10, further comprising:
receiving the timestamped delivery receipt from the local SMSC;
creating a modified message at a real-time SMS gateway; and
sending the modified message to the application server for processing.

12. A method according to claim 11, further comprising synchronising the delivery time with a global clock of the application server.

13. A method according to claim 11, further comprising synchronising the timestamp information with a global clock of the application server.

14. A method according to claim 13, wherein the synchronising step comprises using the synchronised timestamp information to determine the quickest correct data received in response to a broadcast request for such data.

15. A method according to any of claims 12, wherein the synchronising step comprises:
creating an offset table storing the clock timing differences between each SMSC and a global clock;
generating a corrected timestamp or delivery time by subtracting the offset from the original timestamp information or delivery time; and
storing the corrected timestamp or delivery time for valid comparison to other corrected timestamps or corrected delivery times.

16. A method according to any of claims 13, wherein the synchronising step comprises:
creating an offset table storing the clock timing differences between each SMSC and a global clock for each SMSC;
extracting the timestamp information and local SMSC ID from a received SMS message;
using the local SMSC ID to look up a corresponding entry in the offset table;
creating a corrected timestamp by subtracting the offset from the original timestamp information; and
storing the corrected timestamp for valid comparison to other corrected timestamps.

17. A method according to claim 16, wherein the creating step comprises:
generating a test message with a request for a delivery receipt;
sending the test message to a specific SMSC using a SIM card of that SMSC;
recording the sending time on a global clock;
receiving the delivery receipt, including a delivery timestamp;
extracting delivery timestamp information;
determining a time offset for the specific SMSC by subtracting the delivery timestamp information from the sending time; and
storing the determined offset in the offset table.

18. A method according to claim 17, wherein the creating step further comprising repeating the generating, sending, recording, receiving determining and storing steps for each of the possible SMSCs in a given geographical region.

19. A system for obtaining timing information regarding the sending of an SMS messages across a mobile communications network, the system comprising:
receiving means for receiving an SMS message forwarded via the local SMSC to the virtual mobile telephone number of a virtual mobile redirector unit, the SMS message incorporating timestamp information specified by the time of receipt of the message as determined by a local clock of the local SMSC and addressing information;
extracting means for extracting the message data, the address information and the timestamp information from the SMS message;
creating means for creating a new data message addressed by the address data and containing the timestamp information and the message data;
a transmitter for transmitting the new data message to an application server for processing of the message data and the timestamp information; and
an application server for acquiring the transmitted new data message, processing the message data and the timestamping information and compiling the results.

20. A method of measuring a response time of a known mobile telecommunications device user, the method comprising:
sending an SMS question message to the local SMSC of the known mobile telecommunications device with a request for a timestamped delivery receipt from the local SMSC, the timestamped delivery receipt indicating a delivery time at which the question message is actually delivered to the known mobile telecommunications device;
processing the received timestamped delivery receipt from the local SMSC and storing the delivery time;
receiving a response message forwarded via the local SMSC to the virtual mobile telephone number of a virtual mobile redirector unit, the response message incorporating timestamp information specified by the time of receipt of the message as determined by the local clock of the local SMSC and addressing information;
extracting response message data, address information and the timestamp information from the response message;
processing the response message data and timestamp information to determine a sending time for the response message to the questions message; and
subtracting the delivery time from the sending time to determine the response time of the mobile telecommunications device user to the question message.

21. A method of synchronising timestamp information added to an SMS message by a local SMSC, the method comprising:
creating an offset table storing the clock timing differences between each SMSC and a global clock for each SMSC;
extracting the timestamp information and local SMSC ID from a received SMS message;
using the local SMSC ID to look up a corresponding entry in the offset table;
creating a corrected timestamp by subtracting the offset from the original timestamp information; and
storing the corrected timestamp for valid comparison to other corrected timestamps.

22. A method according to claim 21, wherein the creating step is executed at times of low network traffic volume.

23. A method according to claim 21, wherein the creating step comprises:
generating a test message with a request for a delivery receipt;
sending the test message to a specific SMSC using a SIM card of that SMSC;
recording the sending time on a global clock;
receiving the delivery receipt, including a delivery timestamp;
extracting delivery timestamp information;
determining a time offset for the specific SMSC by subtracting the delivery timestamp information from the sending time; and
storing the determined offset in the offset table.

24. A method according to claim 23, wherein the creating step further comprising repeating the generating, sending, recording, receiving determining and storing steps for each of the possible SMSCs in a given geographical region.

25. A method according to claim 24, wherein the repeating step comprises repeating the generating, sending, recording, receiving determining and storing steps for each of the possible SMSCs in a given geographical region at regularly spaced time intervals.
